(19) United States
(12) Patent Application Publication
(10) Pub. No.: US 2025/0102088 A1
(43) Pub. Date: Mar. 27, 2025

(54) PLASTIC CORRUGATED PIPE DUAL WALL TO CONCRETE MANHOLE SLEEVE ADAPTER

(71) Applicant: Advanced Drainage Systems, Inc., Hilliard, OH (US)

(72) Inventors: Joshua CISLO, Findlay, OH (US); Mark KNAPP, Ravenna, OH (US); Tim TOLLIVER, Macedonia, OH (US)

(73) Assignee: Advanced Drainage Systems, Inc., Hilliard, OH (US)

(21) Appl. No.: 18/889,549

(22) Filed: Sep. 19, 2024

Related U.S. Application Data
(60) Provisional application No. 63/584,764, filed on Sep. 22, 2023.

(51) Int. Cl. F16L 25/00; F16L 21/02

(52) U.S. Cl. CPC F16L 25/0036; F16L 21/02

(57) ABSTRACT

A sleeve adapter for installation over a corrugated pipe is provided. The sleeve adapter may comprise a tubular body, wherein the tubular body may have a smooth outer surface, a first monofilament wire connected by a first one-way clamp, wherein the first monofilament wire may extend around a first end of the tubular body, a second monofilament wire connected by a second one-way clamp, wherein the second monofilament wire may extend around a second end of the tubular body, a flexible elastomer hinge extending around the tubular body, and a plurality of sealing surface fins extending outwardly from an inner surface of the tubular body.

### CROSS-REFERENCE TO RELATED APPLICATION

This application claims the benefit of U.S. Provisional Application No. 63/584,764, filed Sep. 22, 2023, which is hereby incorporated by reference in its entirety.

### TECHNICAL FIELD

This disclosure relates generally to systems, methods, and apparatuses for drainage structures and fluid management systems, and more particularly, to providing connections between drainage structures and corrugated piping materials.

### BACKGROUND

Various municipal and private stormwater collection and conveyance systems may involve the connection of a drainage structure, such as a concrete manhole or inlet, with pipes configured to convey fluid into or away from the drainage structure. Drainage structures may include precast concrete manholes with openings formed in a side of the manhole for receiving the pipe. Alternatively, openings may be created in a drainage structure by boring holes into the structure for receiving the pipe. Boot connectors, which may be cast in a pre-cast concrete manhole, may be installed at the opening to facilitate a connection between the manhole and pipes. In addition to concrete manholes, other drainage structures formed of various plastic materials may also be used, which may also include openings for receiving pipes.

The connection between a drainage structure and pipes may be prone to leaks. Current techniques to provide a watertight connection between a drainage structure and pipe may include welding sheets of polypropylene to an outer diameter of a pipe to create a smooth sealing surface. Other techniques may include using a triple wall pipe and a specialized gasket to create a smooth sealing surface. Such techniques may be time consuming and costly when connecting pipes to a drainage structure.

Therefore, solutions are needed to provide a watertight connection between a drainage structure and pipes that is easy and cost-effective to install. Such solutions should provide a smooth sleeve adapter around a dual wall pipe that may be easily and adjustably tightened around the dual wall pipe. The sleeve adapter should further create a smooth outer surface around the diameter of a corrugated pipe to facilitate a watertight connection with a cast-in boot connector of a drainage structure to prevent water from leaking from the connection between the drainage structure and the pipes. The sleeve adapter should further include an integrated sealing surface that may allow for a watertight connection between the sleeve adapter and the corrugations of a corrugated pipe.

### SUMMARY

The disclosed embodiments describe systems, methods, and apparatuses for providing a connection between drainage structures and corrugated piping materials. These systems, methods, and apparatuses may include a sleeve adapter for installation over a corrugated pipe. For example, in an embodiment, the sleeve adapter may comprise a tubular body, wherein the tubular body may have a smooth outer surface, a first monofilament wire connected by a first one-way clamp, wherein the first monofilament wire may extend around a first end of the tubular body, a second monofilament wire connected by a second one-way clamp, wherein the second monofilament wire may extend around a second end of the tubular body, a flexible elastomer hinge extending around the tubular body, and a plurality of sealing surface fins extending outwardly from an inner surface of the tubular body.

According to a disclosed embodiment, the first monofilament wire and the second monofilament wire may be configured to secure the sleeve adapter over the corrugated pipe.

According to a disclosed embodiment, the plurality of sealing surface fins may be configured to engage with a corrugation of the corrugated pipe.

According to a disclosed embodiment, the first monofilament wire and the second monofilament wire may comprise a steel wire.

According to a disclosed embodiment, the first monofilament wire and the second monofilament wire may comprise a nylon wire.

According to a disclosed embodiment, the elastomer hinge may comprise a coextruded multi-durometer thermoplastic vulcanizate (“TPV”) material.

According to a disclosed embodiment, the plurality of sealing surface fins may be configured to create a watertight seal with a corrugation of the corrugated pipe.

According to a disclosed embodiment, a land length of the sleeve adapter may be between approximately 5 inches and approximately 24 inches.

According to a disclosed embodiment, an overall length of the sleeve adapter may be between approximately 16 inches and approximately 36 inches.

According to a disclosed embodiment, the first one-way clamp and the second one-way clamp may be configured to adjust a tightness of the first monofilament wire and the second monofilament wire.

The disclosed embodiments further comprise a sleeve adapter for installation over a corrugated pipe. For example, the sleeve adapter may comprise a tubular body, wherein the tubular body may have a smooth outer surface, a monofilament wire extending around one end of the tubular body, a flexible elastomer hinge extending around the tubular body, and a plurality of sealing surface fins extending outwardly from an inner surface of the tubular body.

According to a disclosed embodiment, the monofilament wire may be configured to secure the sleeve adapter over the corrugated pipe.

According to a disclosed embodiment, the elastomer hinge may be configured to allow the sleeve adapter to slide over the corrugated pipe.

According to a disclosed embodiment, the sleeve adapter may have a thickness of between approximately 0.20 inches and approximately 0.40 inches.

According to a disclosed embodiment, the sleeve adapter may have a thickness of approximately 0.30 inches.

According to a disclosed embodiment, the plurality of sealing surface fins may extend a length of between approximately 6 inches and approximately 7 inches.

According to a disclosed embodiment, the smooth outer surface may be configured to create a watertight surface over the corrugated pipe.

According to a disclosed embodiment, the monofilament wire may be secured to the sleeve adapter by a one-way clamp.

According to a disclosed embodiment, the one-way clamp may be configured to adjust a tightness of the monofilament wire.

According to a disclosed embodiment, the flexible elastomer hinge may comprise a coextruded multi-durometer thermoplastic vulcanizate (“TPV”) material.

According to a disclosed embodiment, the monofilament wire may comprise a nylon wire or a steel wire.

Additional features and advantages of the disclosed embodiments will be set forth in part in the description that follows, and in part will be obvious from the description, or may be learned by practice of the disclosed embodiments.

It is to be understood that both the foregoing general description and the following detailed description are examples and explanatory only and are not restrictive of the disclosed embodiments.

The accompanying drawings constitute a part of this specification. The drawings illustrate several embodiments of the present disclosure and, together with the description, serve to explain the principles of the disclosed embodiments.

### BRIEF DESCRIPTION OF THE DRAWINGS

FIG. 1 depicts pipes connected to a drainage structure by sleeve adapters, according to disclosed embodiments.

FIG. 2A depicts a section cut of a sleeve adapter, according to disclosed embodiments.

FIG. 2B depicts a section cut of a sleeve adapter connected to a pipe, according to disclosed embodiments.

FIG. 2C depicts a perspective view of a sleeve adapter connected to a pipe, according to disclosed embodiments.

FIG. 2D depicts an enlarged view of a sleeve adapter connected to a pipe, according to disclosed embodiments.

FIG. 2E depicts an enlarged view of an inner side of a sleeve adapter, according to disclosed embodiments.

FIG. 3 depicts a section cut of a sleeve adapter connected to a pipe, according to disclosed embodiments.

FIG. 4 depicts a section cut of a sleeve adapter connected to a pipe, according to disclosed embodiments.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing connection means between a drainage structure and pipes. The disclosed embodiments provide a sleeve adapter with a smooth outer surface that may facilitate a watertight connection between a corrugated pipe and a drainage structure. Further, the disclosed embodiments provide a sleeve adapter that may be easily and adjustably installed over the corrugations of a corrugated pipe. The disclosed embodiments may further include an integrated sealing surface that may provide a watertight connection between the sleeve adapter and corrugations of a corrugated pipe. The sleeve adapter disclosed herein may be cost-effective and easy to install, which may minimize the cost and labor required to provide a watertight connection between a drainage structure and pipe.

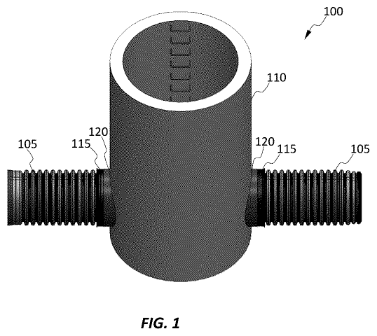

FIG. 1 depicts drainage structure system 100 including manhole 110 with connected pipes 105. In some embodiments, manhole 110 may be precast and formed of concrete. In other embodiments, manhole 110 may comprise a drainage structure made of plastic. Although FIG. 1 depicts a circular manhole 110, manhole 110 may be square, rectangular, or any other shape. Manhole 110 may comprise openings in the walls of manhole 110 that may allow for the flow of water between pipes 105 and manhole 110. Boot 120 may be pre-cast into concrete manhole 110 to facilitate a connection between manhole 110 and pipes 105. Boot 120 may comprise a pipe-to-manhole connection that may extend horizontally from an opening in manhole 110 to facilitate a watertight seal between manhole 110 and pipes 105. As depicted in FIG. 1, concrete manhole 110 may include corrugated pipes 105 upstream and downstream of manhole 110. Pipes 105 may comprise a single wall, dual wall, or triple wall corrugated pipe formed of various plastic materials. In some embodiments, pipes 105 may be formed of other non-plastic materials. In some embodiments, pipes 105 may comprise a dual wall corrugated pipe formed of polypropylene. In some embodiments, pipes 105 may have a diameter between 30 inches and 60 inches. In other embodiments, a diameter of pipes 105 may be less than 30 inches or greater than 60 inches. Although FIG. 1 depicts concrete manhole 110 with two connected pipes 105, more or fewer pipes 105 may be connected to manhole 110. Pipes 105 may be connected to boots 120 of manhole 110 through sleeve adapters 115. Sleeve adapters 115 may be connected to pipes 105 to provide a smooth outer surface to connect with boots 120. The smooth outer surface of sleeve adapters 115 may allow for a watertight connection between pipes 105 and boots 120 of manhole 110.

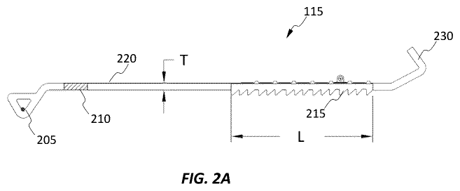

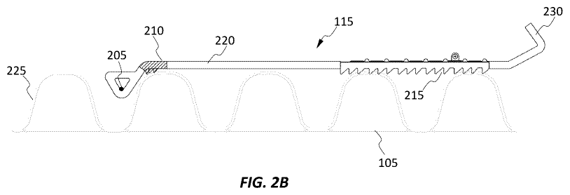

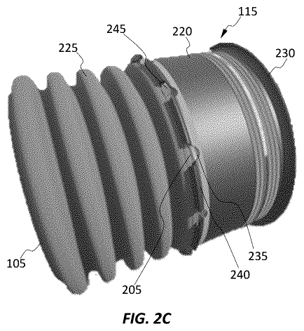

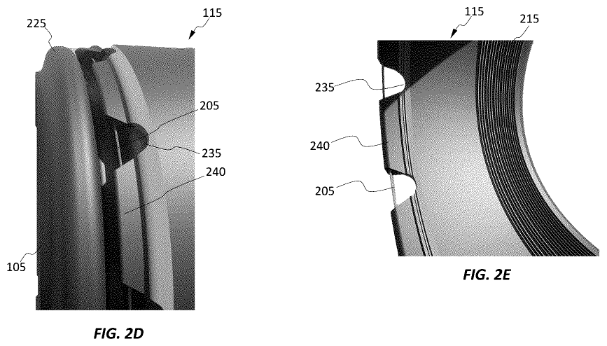

FIG. 2A depicts a section cut of sleeve adapter 115. Sleeve adapter 115 may comprise a tubular body which may extend around the outer circumference of a pipe, such as pipe 105 as depicted in FIG. 1. Sleeve adapter 115 may further comprise a monofilament wire 205. Monofilament wire 205 may extend around an end of the tubular body of sleeve adapter 115 to secure sleeve adapter 115 in a desired position on pipe 105. Monofilament wire 205 may be tightened or loosened through use of a one-way clamp (as depicted in FIG. 2C) to install sleeve adapter 115 around pipe 105 and secure sleeve adapter 115 in a desired location on pipe 105. Sleeve adapter 115 may further comprise hinge 210. Hinge 210 may comprise a flexible elastomer hinge which may allow sleeve adapter 115 to slide around pipe 105 to a desired position on pipe 105. Hinge 210 may allow sleeve adapter 115 to expand as sleeve adapter 115 is installed around pipe 105. Hinge 210 may comprise a coextruded multi-durometer thermoplastic vulcanizate (“TPV”) material. Sleeve adapter 115 may further comprise hook 230. Hook 230 may provide a rounded grip area around the circumference of sleeve adapter 115 to allow an installer to position sleeve adapter 115 around pipe 105 (not shown in FIG. 2A). Sleeve adapter 115 may also comprise fins 215. Fins 215 may comprise an integrated sealing surface on sleeve adapter 115. Fins 215 may comprise teeth which may extend outwardly from an inner surface of sleeve adapter 115 to crush and form a seal around the crown of the corrugations of pipe 105. Fins 215 may secure sleeve adapter 115 in a desired position on pipe 105 and may provide an integrated sealing element that may provide a watertight seal between sleeve adapter 115 and the corrugations of pipe 105. In some embodiments, fins 215 may extend along sleeve adapter 115 for a length L of between approximately 6 inches and approximately 7 inches. In some embodiments, fins 215 may extend along sleeve adapter 115 for a length L of 6.12 inches. In other embodiments, length L of fins 215 may be less than 6 inches or greater than 7 inches. A distance between hinge 210 and fins 215 may be adjusted depending on the diameter of pipe 105 or other factors. The tubular body of sleeve adapter 115 may comprise a smooth outer surface 220. Smooth outer surface 220 may create a smooth sealing surface on the outer wall of pipe 105. Smooth outer surface 220 may facilitate a watertight connection between pipe 105 and boot 120 of manhole 110 (as depicted in FIG. 1). In some embodiments, thickness T of sleeve adapter 115 may be about 0.30 inches. In some embodiments, thickness T of sleeve adapter 115 may be between about 0.20 inches and approximately 0.40 inches, while in other embodiments thickness T of sleeve adapter 115 may be less than 0.20 inches or greater than 0.40 inches.

FIG. 2B depicts a section cut of sleeve adapter 115 installed on pipe 105. Pipe 105 may comprise a plurality of corrugations 225. Sleeve adapter 115 may comprise a tubular body which may extend around the outer circumference of pipe 105. Sleeve adapter 115 may be installed over corrugations 225 of pipe 105 to provide a smooth sealing surface when connecting pipe 105 to a manhole, such as manhole 110 as depicted in FIG. 1. Hook 230 may comprise a rounded grip area around a circumference of sleeve adapter 115 to allow an installer to grip sleeve adapter 115 while installing sleeve adapter 115 around pipe 105. As depicted in FIG. 2B, monofilament wire 205 may be tightened using a one-way clamp (as depicted in FIG. 2C) to secure sleeve adapter 115 between corrugations 225 of pipe 105. For example, monofilament wire 205 may be pulled through a one-way clamp to tighten monofilament wire 205 within the one-way clamp and secure sleeve adapter 115 between corrugations 225 of pipe 105. The one-way clamp may secure monofilament wire 205 without allowing monofilament wire 205 to loosen or release through the one-way clamp. Elastomer hinge 210 may allow sleeve adapter 115 to slide over pipe 105 to a desired position on pipe 105. Fins 215 may engage with corrugations 225 of pipe 105 to secure sleeve adapter 115 in position on pipe 105. Further, fins 215 may provide a watertight connection between sleeve adapter 115 and pipe 105. Smooth outer surface 220 of sleeve adapter 115 may create a smooth sealing surface when pipe 105 with sleeve adapter 115 is installed within a compatible boot, such as boot 120 of manhole 110.

FIG. 2C depicts a perspective view of sleeve adapter 115 installed over corrugations 225 of pipe 105, in accordance with disclosed embodiments. As depicted in FIG. 2C, smooth surface 220 of sleeve adapter 115 may create a smooth sealing surface over corrugations 225 of pipe 105. Smooth surface 220 may facilitate a watertight seal between pipe 105 and a manhole, such as manhole 110 as depicted in FIG. 1. Hook 230 may comprise a rounded grip area extending around a circumference of sleeve adapter 115 that may allow an installer to position sleeve adapter 115 on pipe 105. The circumference of one end of sleeve adapter 115 may include a plurality of channels 240 spaced apart between gaps 235. Channels 240 may comprise hollow extensions around a portion of the circumference of sleeve adapter 115 through which monofilament wire 205 may extend. Channels 240 may surround monofilament wire 205 to hold monofilament wire 205 in place around the circumference of sleeve adapter 115. Gaps 235 may be provided between channels 240. Gaps 235 may comprise an opening between channels 240 so that monofilament wire 205 may be viewed by an installer. Gaps 235 may further allow an installer to adjust the positioning of monofilament wire 205 when installing sleeve adapter 115 around pipe 105. Monofilament wire 205 may be secured through channels 240 by one-way clamp 245. One-way clamp 245 may be positioned at one of gaps 235. When installing sleeve adapter 115 around pipe 105, monofilament wire 205 may be tightened by pulling monofilament wire 205 through one-way clamp 245 when sleeve adapter 115 is positioned around pipe 105. Tightening monofilament wire 205 may secure sleeve adapter 115 in a desired position over corrugations 225 of pipe 105.

FIG. 2D depicts an enlarged view of sleeve adapter 115. As depicted in FIG. 2D, monofilament wire 205 may extend through channels 240, so that monofilament wire 205 may be secured around a circumference of sleeve adapter 115 when sleeve adapter 115 is installed around corrugations 225 of pipe 105. The circumference of sleeve adapter 115 may further include gaps 235 between channels 240. Gaps 235 may allow an installer to view monofilament wire 205 to determine the position and tightness of monofilament wire 205 when sleeve adapter 115 is installed over pipe 105. Gaps 235 may further allow an installer to adjust a position or tightness of monofilament wire 205 when installing sleeve adapter 115 over pipe 105.

FIG. 2E depicts an enlarged view of the inner side of sleeve adapter 115. As depicted in FIG. 2E, monofilament wire 205 may extend through channels 240. Channels 240 may secure monofilament wire 205 along the outer circumference of sleeve adapter 115. Gaps 235 may be positioned between channels 240 and monofilament wire 205 may be exposed at gaps 235 between channels 240. FIG. 2E further depicts fins 215 which may extend outwardly from the inner surface of sleeve adapter 115. Fins 215 may crush and form a seal around the crown of the corrugations of a corrugated pipe to provide a watertight connection between sleeve adapter 115 and the corrugated pipe.

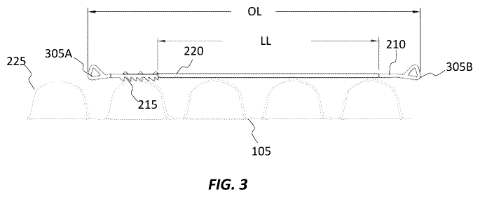

FIG. 3 depicts a section cut of an alternative embodiment of sleeve adapter 115 installed on pipe 105. As depicted in FIG. 3, pipe 105 may comprise a plurality of corrugations 225. Sleeve adapter 115 may comprise a tubular body which may extend around the outer circumference of pipe 105. Sleeve adapter 115 may be installed over corrugations 225 of pipe 105 to provide a smooth sealing surface when connecting pipe 105 to a manhole, such as manhole 110 as depicted in FIG. 1. Sleeve adapter 115 may comprise a first monofilament wire 305A and a second monofilament wire 305B. Monofilament wire 305A may extend around a first end of sleeve adapter 115 and monofilament wire 305B may extend around a second, opposite end of sleeve adapter 115. In some embodiments, the first end and the second end may comprise a plurality of channels, such as channels 240 as depicted in FIGS. 2C-2E, spaced apart between a plurality of gaps, such as gaps 235 as depicted in FIGS. 2C-2E. The plurality of channels may secure monofilament wires 305A and 305B around the circumferences of the first end and the second end of sleeve adapter 115. The plurality of gaps may allow an installer to view and adjust the positioning of monofilament wires 305A and 305B when installing sleeve adapter 115 around pipe 105. Monofilament wires 305A and 305B may comprise nylon cable, steel cable, or cable made from any other suitable material. In some embodiments, monofilament wires 305A and 305B may each have a diameter that may range from 3.5 millimeters to 5.5 millimeters (4.5 gauge to 9.5 gauge). In other embodiments, monofilament wire 305A and 305B may have a diameter of a greater or lesser size. In some embodiments, monofilament wires 305A and 305B may each comprise a 4-millimeter (8 gauge) nylon cable.

Monofilament wire 305A and monofilament wire 305B may each be threaded through one-way clamps (as depicted in FIG. 2C). The one-way clamps may provide a secure connection of monofilament wire 305A around a first end of sleeve adapter 115 and monofilament wire 305B around a second end of sleeve adapter 115. Monofilament wires 305A and 305B may each be tightened through respective one-way clamps by pulling monofilament wires 305A and 305B more tightly through the one-way clamps to secure sleeve adapter 115 between corrugations 225 of pipe 105. The one-way clamps may maintain monofilament wires 305A and 305B in a tightened position so that sleeve adapter 115 may be secured at a desired position on pipe 105. In some embodiments, at least one of monofilament wire 305A or 305B may be released from the one-way clamp using a screwdriver if, for example, sleeve adapter 115 needs to be adjusted or moved on pipe 105. In other embodiments, at least one of monofilament wire 305A or 305B may be cut from the one-way clamp to allow sleeve adapter 115 to be adjusted or moved on pipe 105.

Sleeve adapter 115 may further comprise hinge 210. Hinge 210 may comprise a flexible elastomer hinge which may allow sleeve adapter 115 to slide around pipe 105 to a desired position on pipe 105. Hinge 210 may allow sleeve adapter 115 to expand as sleeve adapter 115 is installed around pipe 105. Hinge 210 may comprise a coextruded multi-durometer thermoplastic vulcanizate (“TPV”) material, which may provide a balance between rigidity and flexibility for sealing. Sleeve adapter 115 may also comprise fins 215. Fins 215 may comprise an integrated sealing surface on sleeve adapter 115. Fins 215 may comprise teeth which may crush and form a seal around the crown of the corrugations of pipe 105. Fins 215 may secure sleeve adapter 115 in a desired position on pipe 105 and may provide an integrated sealing element that may provide a watertight seal between sleeve adapter 115 and the corrugations of pipe 105. Sleeve adapter 115 may comprise a smooth outer surface 220. Smooth outer surface 220 may create a smooth sealing surface on the outer wall of corrugated pipe 105. Smooth outer surface 220 may facilitate a watertight connection between pipe 105 and boot 120 of manhole 110. Sleeve adapter 115 may comprise land length LL. Land length LL may create a smooth, watertight sealing surface on the outer wall of pipe 105 when pipe 105 is installed, for example, within a compatible boot with compression gaskets. In some embodiments, land length LL may be between approximately 5 inches and approximately 24 inches. In some embodiments, land length LL may be 14.24 inches. In other embodiments, land length LL may be less than 5 inches or greater than 24 inches. In some embodiments, overall length OL of sleeve adapter 115 may be between approximately 16 inches and approximately 36 inches. In some embodiments, overall length OL of sleeve adapter 115 may be 21.42 inches. In other embodiments, overall length OL of sleeve adapter 115 may be less than 16 inches or greater than 36 inches.

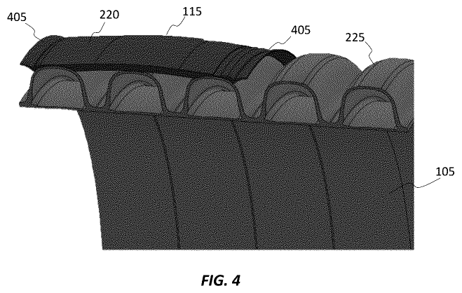

FIG. 4 depicts an alternative embodiment of sleeve adapter 115 installed on pipe 105. As depicted in FIG. 4, sleeve adapter 115 may not include monofilament wires around either end of sleeve adapter 115. In such embodiments, sleeve adapter 115 may be sized to tightly fit around pipe 105 without the use of monofilament wires to secure sleeve adapter 115 in place. Sleeve adapter 115 may be installed around pipe 105 using hooks 405. Hooks 405 may comprise a rounded grip area around the circumference of each end of sleeve adapter 115 which may allow an installer to pull sleeve adapter 115 over corrugations 225 of pipe 105. As depicted in FIG. 4, sleeve adapter 115 may create smooth outer surface 220 over corrugations 225 of pipe 105. Smooth outer surface 220 may facilitate a watertight seal when pipe 105 with sleeve adapter 115 is installed within a compatible boot, such as boot 120 of manhole 110 as depicted in FIG. 1. Once pipe 105 is wrapped in sleeve adapter 115, pipe 105 may be inserted into a boot, such as boot 120 of manhole 110, to create a seal between sleeve adapter 115 and boot 120.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A sleeve adapter for installation over a single corrugated pipe, the sleeve adapter comprising:
a tubular body, wherein the tubular body has a smooth outer surface;
a first monofilament wire connected by a first one-way clamp, wherein the first monofilament wire extends around a first end of the tubular body;
a second monofilament wire connected by a second one-way clamp, wherein the second monofilament wire extends around a second end of the tubular body;
a flexible elastomer hinge extending around the tubular body; and
a plurality of sealing surface fins extending outwardly from an inner surface of the tubular body.

2. The sleeve adapter of claim 1, wherein the first monofilament wire and the second monofilament wire are configured to secure the sleeve adapter over the corrugated pipe.

3. The sleeve adapter of claim 1, wherein the plurality of sealing surface fins is configured to engage with a corrugation of the corrugated pipe.

4. The sleeve adapter of claim 1, wherein the first monofilament wire and the second monofilament wire comprise a steel wire.

5. The sleeve adapter of claim 1, wherein the first monofilament wire and the second monofilament wire comprise a nylon wire.

6. The sleeve adapter of claim 1, wherein the elastomer hinge comprises a coextruded multi-durometer thermoplastic vulcanizate material.

7. The sleeve adapter of claim 1, wherein the plurality of sealing surface fins is configured to create a watertight seal with a corrugation of the corrugated pipe.

8. The sleeve adapter of claim 1, wherein a land length of the sleeve adapter is between approximately 5 inches and approximately 24 inches.

9. The sleeve adapter of claim 1, wherein an overall length of the sleeve adapter is between approximately 16 inches and approximately 36 inches.

10. The sleeve adapter of claim 1, wherein the first one-way clamp and the second one-way clamp are configured to adjust a tightness of the first monofilament wire and the second monofilament wire.

11. A sleeve adapter for installation over a single corrugated pipe, the sleeve adapter comprising:
a tubular body, wherein the tubular body has a smooth outer surface;
a monofilament wire extending around an end of the tubular body;
a flexible elastomer hinge extending around the tubular body; and
a plurality of sealing surface fins extending outwardly from an inner surface of the tubular body.

12. The sleeve adapter of claim 11, wherein the monofilament wire is configured to secure the sleeve adapter over the corrugated pipe.

13. The sleeve adapter of claim 11, wherein the elastomer hinge is configured to allow the sleeve adapter to slide over the corrugated pipe.

14. The sleeve adapter of claim 11, wherein the sleeve adapter has a thickness of between approximately 0.20 inches and approximately 0.40 inches.

15. The sleeve adapter of claim 11, wherein the plurality of sealing surface fins extends a length of between approximately 6 inches and approximately 7 inches.

16. The sleeve adapter of claim 11, wherein the smooth outer surface is configured to create a watertight surface over the corrugated pipe.

17. The sleeve adapter of claim 11, wherein the monofilament wire is secured to the sleeve adapter by a one-way clamp.

18. The sleeve adapter of claim 17, wherein the one-way clamp is configured to adjust a tightness of the monofilament wire.

19. The sleeve adapter of claim 11, wherein the flexible elastomer hinge comprises a coextruded multi-durometer thermoplastic vulcanizate material.

20. The sleeve adapter of claim 11, wherein the monofilament wire comprises a nylon wire or a steel wire.
